(19) United States
(12) Patent Application Publication
(10) Pub. No.: US 2024/0386282 A1
(43) Pub. Date: Nov. 21, 2024

(54) METHOD FOR COMMUNICATION BETWEEN AI/ML CAPABLE CLIENTS DURING FEDERATED LEARNING

(71) Applicant: TENCENT AMERICA LLC, Palo Alto, CA (US)

(72) Inventor: Iraj SODAGAR, Los Angeles, CA (US)

(73) Assignee: TENCENT AMERICA LLC, Palo Alto, CA (US)

(21) Appl. No.: 18/663,634

(22) Filed: May 14, 2024

Related U.S. Application Data
(60) Provisional application No. 63/466,609, filed on May 15, 2023.
(60) Provisional application No. 63/466,604, filed on May 15, 2023.

(51) Int. Cl. G06N 3/098

(52) U.S. Cl. CPC G06N 3/098

(57) ABSTRACT

A method and apparatus comprising computer code configured to cause a processor or processors to envelope a message, of one or more federated learning messages, by a control message format, the control message format comprising a plurality of fields respectively indicating ones of an identifier of the message, a size of the message, a type of the message, and a body of the message, and control the artificial intelligence/machine learning federated learning based on the message enveloped by the control message format.

### CROSS-REFERENCE TO RELATED APPLICATION

This application claims priority to U.S. provisional application 63/466,604, filed on May 15, 2023, and to U.S. provisional application 63/466,609, filed on May 15, 2023, the disclosures of which are incorporated herein by reference in their entireties.

### TECHNICAL FIELD

This disclosure provides a method for communication between devices with AI/ML capability through a service to enable federated learning among them.

### BACKGROUND

In federated learning, each device uses its local data and possibly part of the server-provided data to improve its AI/ML model and then communicate its improvements to servers and consequently to the other devices.

Artificial intelligence (AI) and machine learning (ML) have been advanced in recent years and found many applications. The application of AI/ML in 5G networks is a new topic. Recently the 3GPP SA4 started a study item on AI/ML for media, which will produce a technical report on the subject.

The objectives of SA4's “Artificial Intelligence (AI) and Machine Learning (ML) for Media” are primarily to identify the media service architectures and relevant service flows, model operation configurations, data components including available data formats, and the data traffic The study item results is being maintained in a permanent document (PD).

While the PD includes different collaboration scenarios between networks and devices, including federated learning, it does not discuss the communication between the network and device during federated learning, and therefore, such deficiencies exist in the computer technology.

And for any of those reasons there is therefore a desire for technical solutions to such problems that arose in computer technology.

### SUMMARY

According to an aspect of the disclosure, there is an apparatus, and similarly a method and computer readable medium, including at least one memory configured to store computer program code; and at least one processor configured to access the computer program code and operate as instructed by the computer program code, the computer program code including: enveloping code configured to cause the at least one processor to envelope a message, of one or more federated learning messages, by a control message format, the control message format comprising a plurality of fields respectively indicating ones of an identifier of the message, a size of the message, a type of the message, and a body of the message; and controlling code configured to cause the at least one processor to control artificial intelligence/machine learning (AI/ML) federated learning based on the message enveloped by the control message format, wherein the AI/ML federated learning comprises a server controlling a plurality of separate devices to implement federated portions the AI/ML federated learning and to respectively report results of implementing the federated portions from each of the plurality of separate devices to the server, and wherein the body of the message indicates at least one of an AI/ML federated learning synchronization among the plurality of separate devices, an device eligibility of the AI/ML federated learning, a model evaluation of the AI/ML federated learning, a model update of the AI/ML federated learning, and an error of the AI/ML federated learning.

The AI/ML federated learning may include rounds of federated learning each being an iteration back and forth between the server and the plurality of separate devices, and the AI/ML federated learning may be implemented in parallel at the plurality of separate devices.

The body of the message may indicate the AI/ML federated learning synchronization among the plurality of devices and that, of a round of the rounds of the federated learning, the federated learning is to begin at a same time at each of the plurality of separated devices.

The body of the message may indicate the device eligibility and one or more criteria of device eligibility for the AI/ML federated learning.

The one or more criteria of device eligibility for the AI/ML federated learning may be any of an operating system, a processor speed, an available memory, an available image library, a number of images, a geographical location, an a language setting.

The model evaluation of the AI/ML federated learning may instruct the plurality of separate devices to implement an evaluation of a model of the AI/ML federated learning.

The model evaluation of the AI/ML federated learning may instruct the plurality of separate devices to implement an evaluation of a model separate from the AI/ML federated learning.

The model update of the AI/ML federated learning may instruct the plurality of separate devices to update parameters of a model of the AI/ML federated learning.

The model update may be one of a first instruction, from the server to the plurality of separate devices, and a second instruction from the at least one of the plurality of separate devices to the server.

### BRIEF DESCRIPTION OF THE DRAWINGS

The above and other features and aspects of embodiments of the disclosure will be apparent from the following description taken in conjunction with the accompanying drawings, in which:

FIG. 1 is a simplified diagram in accordance with embodiments;

FIG. 2 is a simplified diagram in accordance with embodiments;

FIG. 3 is a simplified diagram in accordance with embodiments;

FIG. 4 is a simplified diagram in accordance with embodiments;

FIG. 5 is a simplified diagram in accordance with embodiments;

FIG. 6 is a simplified diagram in accordance with embodiments; and

FIG. 7 is a simplified diagram in accordance with embodiments.

### DETAILED DESCRIPTION

The following detailed description of example embodiments refers to the accompanying drawings. The same reference numbers in different drawings may identify the same or similar elements.

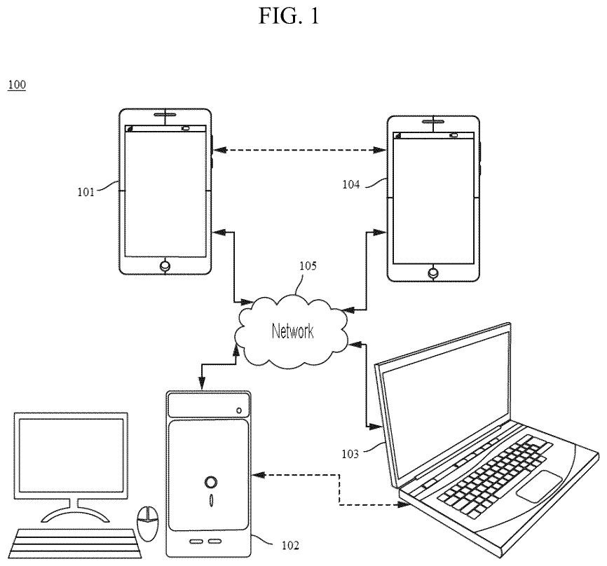

FIG. 1 illustrates a simplified block diagram of a communication system 100 according to an embodiment of the present disclosure. The communication system 100 may include at least two terminals 102 and 103 interconnected via a network 105. For unidirectional transmission of data, a first terminal 103 may code video data at a local location for transmission to the other terminal 102 via the network 105. The second terminal 102 may receive the coded video data of the other terminal from the network 105, decode the coded data and display the recovered video data. Unidirectional data transmission may be common in media serving applications and the like.

FIG. 1 illustrates a second pair of terminals 101 and 104 provided to support bidirectional transmission of coded video that may occur, for example, during videoconferencing. For bidirectional transmission of data, each terminal 101 and 104 may code video data captured at a local location for transmission to the other terminal via the network 105. Each terminal 101 and 104 also may receive the coded video data transmitted by the other terminal, may decode the coded data and may display the recovered video data at a local display device.

In FIG. 1, the terminals 101, 102, 103 and 104 may be illustrated as servers, personal computers and smart phones but the principles of the present disclosure are not so limited. Embodiments of the present disclosure find application with laptop computers, tablet computers, media players and/or dedicated video conferencing equipment. The network 105 represents any number of networks that convey coded video data among the terminals 101, 102, 103 and 104, including for example wireline and/or wireless communication networks. The communication network 105 may exchange data in circuit-switched and/or packet-switched channels. Representative networks include telecommunications networks, local area networks, wide area networks and/or the Internet. For the purposes of the present discussion, the architecture and topology of the network 105 may be immaterial to the operation of the present disclosure unless explained herein below.

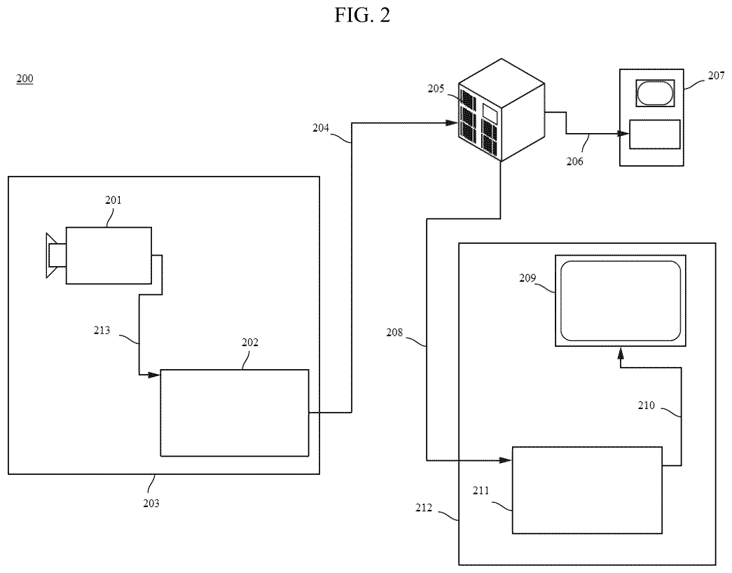

FIG. 2 illustrates, as an example for an application for the disclosed subject matter, the placement of a video encoder and decoder in a streaming environment. The disclosed subject matter can be equally applicable to other video enabled applications, including, for example, video conferencing, digital TV, storing of compressed video on digital media including CD, DVD, memory stick and the like, and so on.

A streaming system may include a capture subsystem 203, that can include a video source 201, for example a digital camera, creating, for example, an uncompressed video sample stream 213. That sample stream 213 may be emphasized as a high data volume when compared to encoded video bitstreams and can be processed by an encoder 202 coupled to the camera 201. The encoder 202 can include hardware, software, or a combination thereof to enable or implement aspects of the disclosed subject matter as described in more detail below. The encoded video bitstream 204, which may be emphasized as a lower data volume when compared to the sample stream, can be stored on a streaming server 205 for future use. One or more streaming clients 212 and 207 can access the streaming server 205 to retrieve copies 208 and 206 of the encoded video bitstream 204. A client 212 can include a video decoder 211 which decodes the incoming copy of the encoded video bitstream 208 and creates an outgoing video sample stream 210 that can be rendered on a display 209 or other rendering device (not depicted). In some streaming systems, the video bitstreams 204, 206 and 208 can be encoded according to certain video coding/compression standards. Examples of those standards are noted above and described further herein.

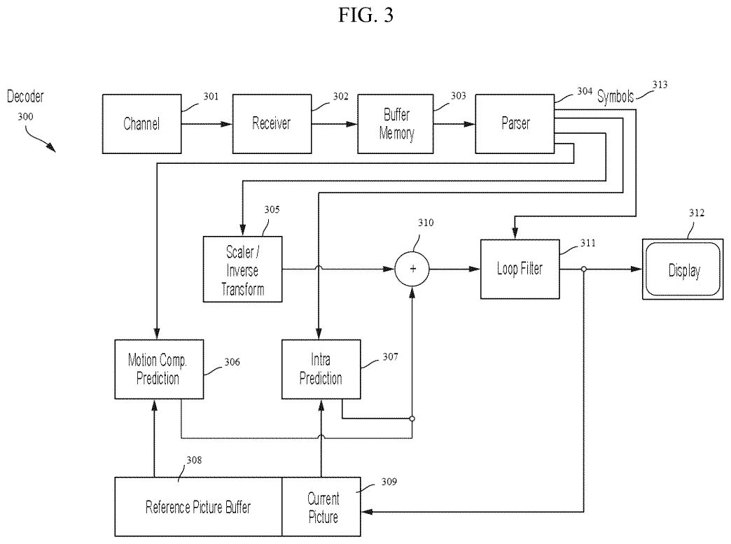

FIG. 3 may be a functional block diagram of a video decoder 300 according to an embodiment of the present invention.

A receiver 302 may receive one or more codec video sequences to be decoded by the decoder 300; in the same or another embodiment, one coded video sequence at a time, where the decoding of each coded video sequence is independent from other coded video sequences. The coded video sequence may be received from a channel 301, which may be a hardware/software link to a storage device which stores the encoded video data. The receiver 302 may receive the encoded video data with other data, for example, coded audio data and/or ancillary data streams, that may be forwarded to their respective using entities (not depicted). The receiver 302 may separate the coded video sequence from the other data. To combat network jitter, a buffer memory 303 may be coupled in between receiver 302 and entropy decoder/parser 304 (“parser” henceforth). When receiver 302 is receiving data from a store/forward device of sufficient bandwidth and controllability, or from an isosychronous network, the buffer 303 may not be needed, or can be small. For use on best effort packet networks such as the Internet, the buffer 303 may be required, can be comparatively large and can advantageously of adaptive size.

The video decoder 300 may include a parser 304 to reconstruct symbols 313 from the entropy coded video sequence. Categories of those symbols include information used to manage operation of the decoder 300, and potentially information to control a rendering device such as a display 312 that is not an integral part of the decoder but can be coupled to it. The control information for the rendering device(s) may be in the form of Supplementary Enhancement Information (SEI messages) or Video Usability Information parameter set fragments (not depicted). The parser 304 may parse/entropy-decode the coded video sequence received. The coding of the coded video sequence can be in accordance with a video coding technology or standard, and can follow principles well known to a person skilled in the art, including variable length coding, Huffman coding, arithmetic coding with or without context sensitivity, and so forth. The parser 304 may extract from the coded video sequence, a set of subgroup parameters for at least one of the subgroups of pixels in the video decoder, based upon at least one parameters corresponding to the group. Subgroups can include Groups of Pictures (GOPs), pictures, tiles, slices, macroblocks, Coding Units (CUs), blocks, Transform Units (TUs), Prediction Units (PUs) and so forth. The entropy decoder/parser may also extract from the coded video sequence information such as transform coefficients, quantizer parameter values, motion vectors, and so forth.

The parser 304 may perform entropy decoding/parsing operation on the video sequence received from the buffer 303, so to create symbols 313. The parser 304 may receive encoded data, and selectively decode particular symbols 313. Further, the parser 304 may determine whether the particular symbols 313 are to be provided to a Motion Compensation Prediction unit 306, a scaler/inverse transform unit 305, an Intra Prediction Unit 307, or a loop filter 311.

Reconstruction of the symbols 313 can involve multiple different units depending on the type of the coded video picture or parts thereof (such as: inter and intra picture, inter and intra block), and other factors. Which units are involved, and how, can be controlled by the subgroup control information that was parsed from the coded video sequence by the parser 304. The flow of such subgroup control information between the parser 304 and the multiple units below is not depicted for clarity.

Beyond the functional blocks already mentioned, decoder 300 can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit 305. The scaler/inverse transform unit 305 receives quantized transform coefficient as well as control information, including which transform to use, block size, quantization factor, quantization scaling matrices, etc. as symbol(s) 313 from the parser 304. It can output blocks comprising sample values, that can be input into aggregator 310.

In some cases, the output samples of the scaler/inverse transform 305 can pertain to an intra coded block; that is: a block that is not using predictive information from previously reconstructed pictures, but can use predictive information from previously reconstructed parts of the current picture. Such predictive information can be provided by an intra picture prediction unit 307. In some cases, the intra picture prediction unit 307 generates a block of the same size and shape of the block under reconstruction, using surrounding already reconstructed information fetched from the current (partly reconstructed) picture 309. The aggregator 310, in some cases, adds, on a per sample basis, the prediction information the intra prediction unit 307 has generated to the output sample information as provided by the scaler/inverse transform unit 305.

In other cases, the output samples of the scaler/inverse transform unit 305 can pertain to an inter coded, and potentially motion compensated block. In such a case, a Motion Compensation Prediction unit 306 can access reference picture memory 308 to fetch samples used for prediction. After motion compensating the fetched samples in accordance with the symbols 313 pertaining to the block, these samples can be added by the aggregator 310 to the output of the scaler/inverse transform unit (in this case called the residual samples or residual signal) so to generate output sample information. The addresses within the reference picture memory form where the motion compensation unit fetches prediction samples can be controlled by motion vectors, available to the motion compensation unit in the form of symbols 313 that can have, for example X, Y, and reference picture components. Motion compensation also can include interpolation of sample values as fetched from the reference picture memory when sub-sample exact motion vectors are in use, motion vector prediction mechanisms, and so forth.

The output samples of the aggregator 310 can be subject to various loop filtering techniques in the loop filter unit 311. Video compression technologies can include in-loop filter technologies that are controlled by parameters included in the coded video bitstream and made available to the loop filter unit 311 as symbols 313 from the parser 304, but can also be responsive to meta-information obtained during the decoding of previous (in decoding order) parts of the coded picture or coded video sequence, as well as responsive to previously reconstructed and loop-filtered sample values.

The output of the loop filter unit 311 can be a sample stream that can be output to the render device 312 as well as stored in the reference picture memory 557 for use in future inter-picture prediction.

Certain coded pictures, once fully reconstructed, can be used as reference pictures for future prediction. Once a coded picture is fully reconstructed and the coded picture has been identified as a reference picture (by, for example, parser 304), the current reference picture 309 can become part of the reference picture buffer 308, and a fresh current picture memory can be reallocated before commencing the reconstruction of the following coded picture.

The video decoder 300 may perform decoding operations according to a predetermined video compression technology that may be documented in a standard, such as ITU-T Rec. H.265. The coded video sequence may conform to a syntax specified by the video compression technology or standard being used, in the sense that it adheres to the syntax of the video compression technology or standard, as specified in the video compression technology document or standard and specifically in the profiles document therein. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver 302 may receive additional (redundant) data with the encoded video. The additional data may be included as part of the coded video sequence(s). The additional data may be used by the video decoder 300 to properly decode the data and/or to more accurately reconstruct the original video data. Additional data can be in the form of, for example, temporal, spatial, or signal-to-noise ratio (SNR) enhancement layers, redundant slices, redundant pictures, forward error correction codes, and so on.

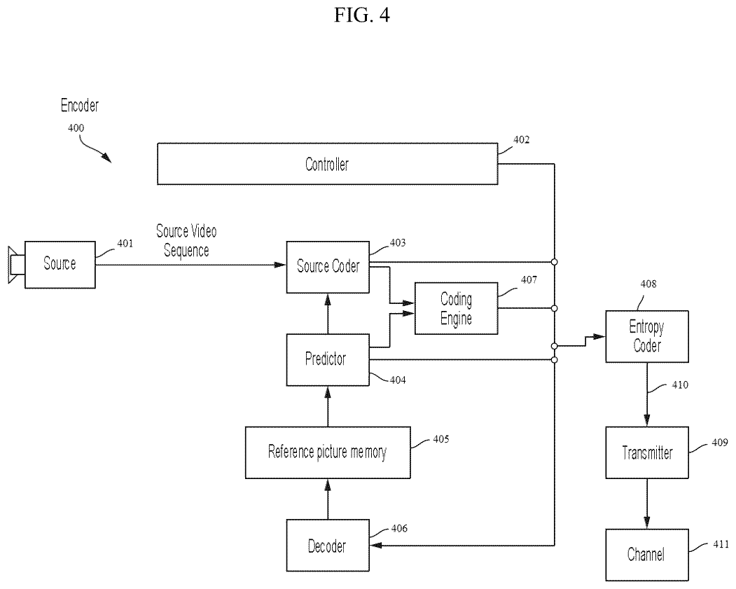

FIG. 4 may be a functional block diagram of a video encoder 400 according to an embodiment of the present disclosure.

The encoder 400 may receive video samples from a video source 401 (that is not part of the encoder) that may capture video image(s) to be coded by the encoder 400.

The video source 401 may provide the source video sequence to be coded by the encoder (303) in the form of a digital video sample stream that can be of any suitable bit depth (for example: 8 bit, 10 bit, 12 bit, . . . ), any colorspace (for example, BT.601 Y CrCB, RGB, . . . ) and any suitable sampling structure (for example Y CrCb 4:2:0, Y CrCb 4:4:4). In a media serving system, the video source 401 may be a storage device storing previously prepared video. In a videoconferencing system, the video source 401 may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the encoder 400 may code and compress the pictures of the source video sequence into a coded video sequence 410 in real time or under any other time constraints as required by the application. Enforcing appropriate coding speed is one function of Controller 402. Controller controls other functional units as described below and is functionally coupled to these units. The coupling is not depicted for clarity. Parameters set by controller can include rate control related parameters (picture skip, quantizer, lambda value of rate-distortion optimization techniques, . . . ), picture size, group of pictures (GOP) layout, maximum motion vector search range, and so forth. A person skilled in the art can readily identify other functions of controller 402 as they may pertain to video encoder 400 optimized for a certain system design.

Some video encoders operate in what a person skilled in the art readily recognizes as a “coding loop.” As an oversimplified description, a coding loop can consist of the encoding part of an encoder 402 (“source coder” henceforth) (responsible for creating symbols based on an input picture to be coded, and a reference picture(s)), and a (local) decoder 406 embedded in the encoder 400 that reconstructs the symbols to create the sample data that a (remote) decoder also would create (as any compression between symbols and coded video bitstream is lossless in the video compression technologies considered in the disclosed subject matter). That reconstructed sample stream is input to the reference picture memory 405. As the decoding of a symbol stream leads to bit-exact results independent of decoder location (local or remote), the reference picture buffer content is also bit exact between local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is well known to a person skilled in the art.

The operation of the “local” decoder 406 can be the same as of a “remote” decoder 300, which has already been described in detail above in conjunction with FIG. 3. Briefly referring also to FIG. 4, however, as symbols are available and en/decoding of symbols to a coded video sequence by entropy coder 408 and parser 304 can be lossless, the entropy decoding parts of decoder 300, including channel 301, receiver 302, buffer 303, and parser 304 may not be fully implemented in local decoder 406.

An observation that can be made at this point is that any decoder technology except the parsing/entropy decoding that is present in a decoder also necessarily needs to be present, in substantially identical functional form, in a corresponding encoder. The description of encoder technologies can be abbreviated as they are the inverse of the comprehensively described decoder technologies. Only in certain areas a more detail description is required and provided below.

As part of its operation, the source coder 403 may perform motion compensated predictive coding, which codes an input frame predictively with reference to one or more previously-coded frames from the video sequence that were designated as “reference frames.” In this manner, the coding engine 407 codes differences between pixel blocks of an input frame and pixel blocks of reference frame(s) that may be selected as prediction reference(s) to the input frame.

The local video decoder 406 may decode coded video data of frames that may be designated as reference frames, based on symbols created by the source coder 403. Operations of the coding engine 407 may advantageously be lossy processes. When the coded video data may be decoded at a video decoder (not shown in FIG. 4), the reconstructed video sequence typically may be a replica of the source video sequence with some errors. The local video decoder 406 replicates decoding processes that may be performed by the video decoder on reference frames and may cause reconstructed reference frames to be stored in the reference picture cache 405. In this manner, the encoder 400 may store copies of reconstructed reference frames locally that have common content as the reconstructed reference frames that will be obtained by a far-end video decoder (absent transmission errors).

The predictor 404 may perform prediction searches for the coding engine 407. That is, for a new frame to be coded, the predictor 404 may search the reference picture memory 405 for sample data (as candidate reference pixel blocks) or certain metadata such as reference picture motion vectors, block shapes, and so on, that may serve as an appropriate prediction reference for the new pictures. The predictor 404 may operate on a sample block-by-pixel block basis to find appropriate prediction references. In some cases, as determined by search results obtained by the predictor 404, an input picture may have prediction references drawn from multiple reference pictures stored in the reference picture memory 405.

The controller 402 may manage coding operations of the video coder 403, including, for example, setting of parameters and subgroup parameters used for encoding the video data.

Output of all aforementioned functional units may be subjected to entropy coding in the entropy coder 408. The entropy coder translates the symbols as generated by the various functional units into a coded video sequence, by loss-less compressing the symbols according to technologies known to a person skilled in the art as, for example Huffman coding, variable length coding, arithmetic coding, and so forth.

The transmitter 409 may buffer the coded video sequence(s) as created by the entropy coder 408 to prepare it for transmission via a communication channel 411, which may be a hardware/software link to a storage device which would store the encoded video data. The transmitter 409 may merge coded video data from the video coder 403 with other data to be transmitted, for example, coded audio data and/or ancillary data streams (sources not shown).

The controller 402 may manage operation of the encoder 400. During coding, the controller 405 may assign to each coded picture a certain coded picture type, which may affect the coding techniques that may be applied to the respective picture. For example, pictures often may be assigned as one of the following frame types:

An Intra Picture (I picture) may be one that may be coded and decoded without using any other frame in the sequence as a source of prediction. Some video codecs allow for different types of Intra pictures, including, for example Independent Decoder Refresh Pictures. A person skilled in the art is aware of those variants of I pictures and their respective applications and features.

A Predictive picture (P picture) may be one that may be coded and decoded using intra prediction or inter prediction using at most one motion vector and reference index to predict the sample values of each block.

A Bi-directionally Predictive Picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded non-predictively, via spatial prediction or via temporal prediction with reference to one previously coded reference pictures. Blocks of B pictures may be coded non-predictively, via spatial prediction or via temporal prediction with reference to one or two previously coded reference pictures.

The video coder 400 may perform coding operations according to a predetermined video coding technology or standard, such as ITU-T Rec. H.265. In its operation, the video coder 400 may perform various compression operations, including predictive coding operations that exploit temporal and spatial redundancies in the input video sequence. The coded video data, therefore, may conform to a syntax specified by the video coding technology or standard being used.

In an embodiment, the transmitter 409 may transmit additional data with the encoded video. The source coder 403 may include such data as part of the coded video sequence. Additional data may comprise temporal/spatial/SNR enhancement layers, other forms of redundant data such as redundant pictures and slices, Supplementary Enhancement Information (SEI) messages, Visual Usability Information (VUI) parameter set fragments, and so on.

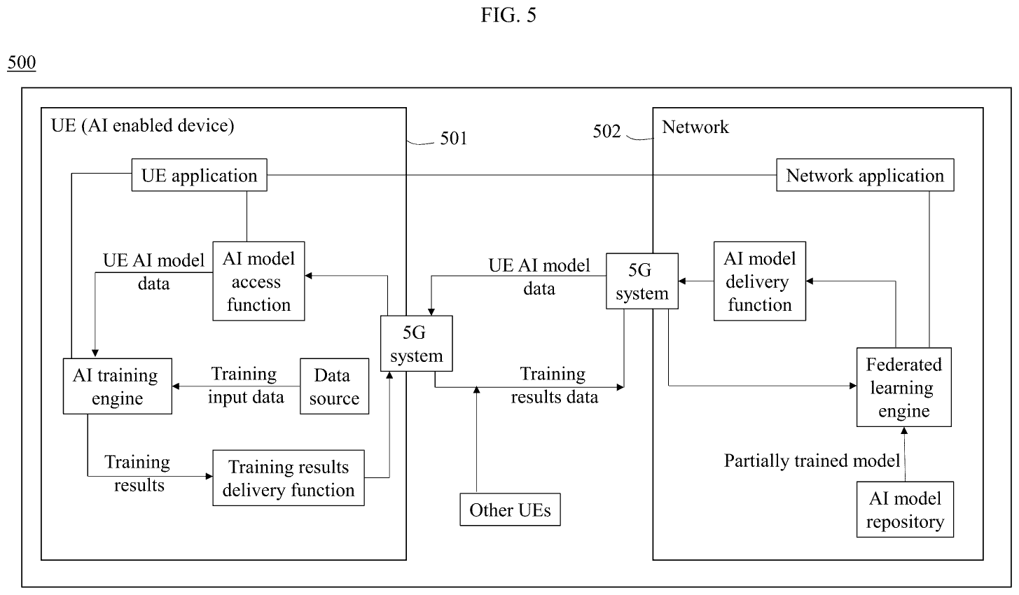

As 3GPP SA4 explores AI/ML for media, a messaging framework for federated learning is provided by embodiments herein. For example, see FIG. 5 showing example 500 as a federated learning architecture according to embodiments herein in light of 3GPP SA4's AI/ML study.

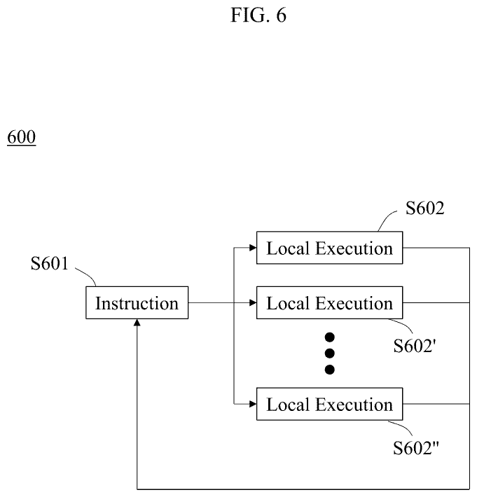

As shown in FIG. 5, the network 502 can provide the AI model to the device 501. This can also be seen in the example 600 of FIG. 6 at step S601. The device 501 can perform local training on the model and provide the results back to the network 501. This can also be seen in the example 600 of FIG. 6 at steps S602, S602′, and S602″, where each of steps S602, S602′, and S602″ represents respective ones of federated devices, one of which being the device 501. The service can use this training result to update the AI model and optionally provide the updated model to the device and other devices. This can be seen as an example of another iteration of the example 600 and at step S601.

Embodiments herein provide for a messaging format for communication between the central service, located on the network 502, and devices, such as device 501, to exchange messages during the federated learning process. The control messages have a common envelope that identifies the source/destination, the specific model under federated learning, the status of federated learning at the destination, the quality/precision of the locally updated model, and other information during the federated learning process.

The structure of a federated learning message is shown in Table 1:

TABLE 1
Federated learning message high-level structure

| Type | Requirement |
|---|---|
| Envelope | Mandatory |
| Messages_number | Mandatory |
| Message_body 1 | Mandatory |
| Message_body 2 | Optional |
| . . . | . . . |
| Message_body N | Optional |

According to embodiments and in light of Table 1, a message consists of an envelope and one or more message bodies. The envelope provides the general information for this message. The Messages Number defines the number of the message bodies in this message. Each message body defines a specific message.

Further, a federated learning message envelope includes the following parameters, shown in Table 2:

TABLE 2
Federated learning message envelope

| Type | Value | Syntax | Requirement |
|---|---|---|---|
| Source_id | A unique value | String | Mandatory |
| | identifying the source | | |
| | Example: “AI/ML | | |
| | server 1234” | | |
| Destination_id | A unique value | Integer | Optional |
| | identifying the | | |
| | destination | | |
| | Example: 112345678 | | |
| Group_id | A unique value | Integer | Optional |
| | identifying the | | This value is |
| | destination group: | | ignored if the |
| | Example: 2123 | | destination_id |
| | | | exists. |
| Model_id | A unique value | Integer | Mandatory |
| | identifying the model | | |
| | under federated | | |
| | learning that this | | |
| | message is about. | | |
| | Example: 91235436 | | |
| Messages_number | An integer value | Integer | Mandatory |
| | larger than 0, defines | | |
| | the number of | | |
| | message bodies in | | |
| | this message. | | |
| | Example: 2 means | | |
| | two message bodies | | |

According to embodiments and as shown in the above Table 2:
1. The source id: a unique id, identifying the source of the message. The source can be a device or node that participates in the federated learning, or a network service/server that coordinates the federated learning.
2. The destination or group id: a unique id for identifying the destination or a group of destinations of the message. The destination can be a device or node that participates in the federated learning, or a network service/server that coordinates the federated learning. If not present, the message is intended for all devices/nodes that are participating in the federated learning.
3. The model id: a unique id, identifying the model under federated learning, so that the recipient of the message applies the message to the specific model.
4. The messages number defines the number of message bodies in this message. A message may contain one or more message bodies.

According to embodiments, when a set of devices, such as one of the devices 501, participates in federated learning, any of those devices can send and receive messages to a service server, such as of the network 502. Each message shall include the above envelope. The envelope allows the identification of the source, destination(s), and the model that is the subject of the message.

The federated learning message body includes the following parameters, shown in Table 3:

TABLE 3
Federated learning message body

| Type | Value | Syntax | Requirement |
|---|---|---|---|
| Message_id | A unique value | Integer | Mandatory |
| | identifying this | | |
| | message: | | |
| | Example: 4123 | | |
| Message_size | An integer shows the | Integer | Mandatory |
| | length of the message | (Double) | |
| | body in bytes. | | |
| Message_type | A value showing the | String | Mandatory |
| | type of message. | | |
| | Example: | | |
| | “Synchronization” | | |
| [The rest of the | Object | N/A | Mandatory |
| message body | | | |
| according to the | | | |
| Message Type] | | | |

According to embodiments and as shown in the above Table 3:
1. The message_id should be assigned in increasing order so that the order of the issued messages can be processed in order of issuance if needed.
2. The message_size defines the length of the entire message body in bytes.
3. The message_type defines the type of message. The body of the message format is defined by the type of the message. A message may have multiple message types. In this case, the message type is followed by the corresponding body.
4. The rest of the message body format and semantics is defined by the message type.

This design, with reference to those Tables 1-3, defines a message framework for control messages during federated learning with the following benefits achieved by embodiments herein:
1. A general envelope and body structure is defined that allows embedding one or more message bodies in one transmission, therefore enabling efficient transmission of multiple messages.
2. The source and the destination or the group of destinations are identified. Therefore a recipient can always find out the source of the message from the message independent of the transmission protocol.
3. The subject model is identified, so that multiple federated learning sessions can work in parallel.
4. The message is uniquely identified. So repeated messages can be detected, and only one is processed. Also, the order of issued messages from one source can be identified, even if they are delivered at different times.
5. Since the length of each message is defined, the parse can skip message bodies if necessary.
6. The message type enables to detection the type of message bodies. So a recipient can parse the message and identify various message bodies and process them accordingly.

As such, embodiments herein provide a control message format for exchanging messages during the federated learning between devices and network, and among devices, wherein the message includes an envelope and one or more message bodies, wherein the message envelope defines the source, one or a group of destination(s), as well as the sender, and the subject model under training as well as one or more message bodies, wherein each message body indicate the message identifier, to detect replicant messages, body size and a message type which defines the remaining of the message body syntax and semantics.

Additionally, there is also provided for AI/ML for media according to example embodiments, there is provided herein a messaging framework, and specific messages for the above exchanges, particularly during federated learning.

As such, there is provided herein control messaging during federated learning, and this innovation defines a messaging format for communication between the central service, located on the network, and devices to exchange messages during the federated learning process. The control messages have a common envelope that identifies the source/destination, the specific model under federated learning, the status of federated learning at the destination, the quality/precision of the locally updated model, and other information during the federated learning process.

As for a definition of “synchronization message” according to embodiments herein, synchronization messages are used to ensure that all devices start the training process simultaneously and progress at the same pace. For example, the server may send a synchronization message to all UEs to start a new round of training.

The behavior of synchronization messages is from a network server, such as of network 502, and to a device, such as the device 501. The server sends a synchronization message to all UEs to start a new round of training at the same time. The message contains the round number and may also contain a timestamp indicating when the training round should begin. This is implemented at S601 of FIG. 6.

As for syntax of synchronization messages, Table 4 is provided:

TABLE 4
Synchronization message body

| Type | Value | Syntax | Cardinality |
|---|---|---|---|
| Message_id | A unique value | Integer | 1 |
| | identifying this | | |
| | message: | | |
| | Example: 4123 | | |
| Message_size | An integer shows the | Integer (Double) | 1 |
| | length of the message | | |
| | body in bytes. | | |
| Message_type | “Synchronization” | String | 1 |
| Round_number | The number of the | Integer | 1 |
| | training round. | | |
| | Example: 4 | | |
| Start time | Unix timestamp | Integer (Double) | 0 . . . 1 |
| Duration | This value indicates | Integer | 0 . . . 1 |
| | the desirable duration | | |
| | of time in seconds to | | |
| | complete this round | | |
| | of training. | | |
| | Example: 10 (means | | |
| | 10 seconds) | | |

Cardinality: 0 = not allowed, 1 = only once, 0 . . . 1 = at most one, 0 . . . N = zero or more, and 1 . . . N = one or more.

Viewing Table 4:
1. The Round_number indicates the training round in a model training. So value 4 means that this synchronization message is for the 4th round of training. According to embodiments that may be a 4^{th} iteration of the example 600 of FIG. 6.
2. The Start_time indicates the start time of the training. This value is optional.
3. The Duration indicates the desirable duration of the training. This value just shows an indication of the desirable time for completing the training round. According to embodiments, there is also provided a “device eligibility message”.

For example, device eligibility messages are used by embodiments herein to define the criteria for selecting the devices that will participate in the training process. For example, the server, such as of network 502, may send a device eligibility message to all devices, including device 501, that belong to the defined group by the application.

The behavior of device eligibility messages is from a network server, such as of network 502, and to a device, such as the device 501. The server sends a device eligibility message to select the devices that meet certain criteria defined by the application. Depending on the number of criteria met, the application assigns a group id to the device. For example, the criteria could contain information about the device's operating system, processor speed, available memory, available image library (number of images . . . ), geographical location of the device, language setting, and other attributes. This is implemented at S601 of FIG. 6.

As for syntax of synchronization messages, Table 5 is provided:

TABLE 5
Syntax (Device eligibility message)

| Type | Value | Syntax | Cardinality |
|---|---|---|---|
| Message_id | A unique value | Integer | 1 |
| | identifying this | | |
| | message: | | |
| | Example: 4123 | | |
| Message_size | An integer shows the | Integer | 1 |
| | length of the message | (Double) | |
| | body in bytes. | | |
| Message_type | “Eligibility” | String | 1 |
| Group_id | A value used for this | Integer | 1 |
| | group | | |
| | Example: 5 | | |
| Application_group_id | A value assigned by | Integer | 0 . . . 1 |
| | the application as the | | |
| | application group id | | |
| | for this device. | | |
| Hardware | The object defining | Object | 0 . . . 1 |
| | the minimum eligible | | |
| | device | | |
| Location | The location of the | Object | 0 . . . 1 |
| | eligible device | | |
| Language | The language setting | String | 0 . . . 1 |
| | of the device for the | | |
| | model/application | | |
| data_library_id | The unique identifier | Integer | 0 . . . 1 |
| | of the data library | | |
| | eligible for the | | |
| | training. | | |

Cardinality: 0 = not allowed, 1 = only once, 0 . . . 1 = at most one, 0 . . . N = zero or more, and 1 . . . N = one or more.

In the above Table 5:
1. The Group_id is used to assign a new id for the devices that meet the eligibility criteria of this message. If the device is eligible, it uses this value as one of its group ids and from now on, it reacts to messages with the same group id.
2. The Application_group_id, is assigned by the application on the device and if that value is equal to the value of this field, then the device is eligible.
3. The Hardware, Location, and Language parameters define the hardware, location, and language eligibility criteria respectively for the device.
4. The Data_library_id defines the data library an eligible device shall have.

Note that if more than one eligibility field exists, the device shall meet all criteria to become eligible according to exemplary embodiments.

According to embodiments, there is also provided a “model evaluation message”. For example, model evaluation messages are used by embodiments herein to evaluate the performance of the global model for each device and make decisions about the training process. After running the learning phase, a device sends a model evaluation message to the server that measures the accuracy of the model. The server can then decide whether to continue training for another round or stop. Alternatively, this message can be used by the server to request the device to perform an evaluation of a newly downloaded global model. As with the above features, the server and device here also may be of the network device 502 and the device 501 respectively.

According to embodiments, the behavior of device eligibility messages is from a network server, such as of network 502, and to a device, such as the device 501. The message contains the metrics to be used for evaluation. This is implemented at S601 of FIG. 6.

According to embodiments, the behavior of device eligibility messages is also from a device, such as the device 501, and to a network server, such as of network 502. The message contains the metrics to be used for evaluation. This is implemented at any of S602, S602′, S602″ of FIG. 6.

As for syntax of device eligibility messages, Table 6 is provided:

TABLE 6
Syntax (Model evaluation message)

| Type | Value | Syntax | Cardinality |
|---|---|---|---|
| Message_id | A unique value | Integer | 1 |
| | identifying this | | |
| | message: | | |
| | Example: 4123 | | |
| Message_size | An integer shows the | Integer | 1 |
| | length of the message | (Double) | |
| | body in bytes. | | |
| Message_type | “Eligibility” | String | 1 |
| Round_number | The number of the | Integer | 1 |
| | training round. | | |
| | Example: 4 | | |
| Metric_number | The number of | Integer | 1 |
| | metrics included in | | |
| | this message. | | |
| Metric | | Object | 1 . . . N |
| Name | Indicate the metric's | String | 1 |
| | name used for the | | |
| | model evaluation | | |
| | Example: “Accuracy” | | |
| Value | The result of | Integer | 1 |
| | evaluation in the | | |
| | metric | | |
| | Example: 90% | | |

Cardinality: 0 = not allowed, 1 = only once, 0 . . . 1 = at most one, 0 . . . N = zero or more, and 1 . . . N = one or more.

In the above Table 6:
1. The Round_number shows the round after which the evaluation is performed.
2. The Metric_number shows the number of metrics included in this message body.
3. The Metric is one or more of the Name-Value pairs showing the name of the metric and the corresponding value obtained in the evaluation.

According to embodiments, there is also provided a “model update message”. For example, model update messages are used by embodiments herein to update the model parameters on the devices after each round of training. For example, the server may send a model update message to all devices to update the global model with the new model parameters. Model update messages are also used to update the global model on the server with the new parameters updated by the local training on the device. . . . As with the above features, the server and device here also may be of the network device 502 and the device 501 respectively and may be implemented at S601, S602, S602′, S602″ respectively.

According to embodiments, the behavior of device eligibility messages is from a network server, such as of network 502, and to a device, such as the device 501. The server sends a model update message to all devices to update the AI/ML model with the new model parameters. The message contains the model id of the AI/ML model to be updated, the updated model parameters that the UE will use to train the model in the next round, and the new model id when the parameters are updated. This is implemented at S601 of FIG. 6 according to embodiments.

According to embodiments, the behavior of device eligibility messages is also from a device, such as the device 501, and to a network server, such as of network 502. After running the training locally, each device may send a model update message to the server with the updated parameters. Together with the received model evaluation message, the server can decide if the global model needs to be updated or not. The model update message then only contains the model id of the AI/ML model used for local training and the updated parameters. This is implemented at any of S602, S602′, S602″ of FIG. 6.

As for syntax of device eligibility messages, Table 7 is provided:

TABLE 7
Syntax (Model update message)

| Type | Value | Syntax | Cardinality |
|---|---|---|---|
| Message_id | A unique value | integer | 1 |
| | identifying this | | |
| | message: | | |
| | Example: 4123 | | |
| Message_size | An integer shows the | integer | 1 |
| | length of the message | (Double) | |
| | body in bytes. | | |
| Message_type | “Model Update” | string | 1 |
| Parameters | Vector of values | array of objects | 1 |
| New_model_id | A unique integer | integer | 1 from server to |
| | identifying the new id | | device. |
| | for the model. | | 0 from device to |
| | | | server. |

Cardinality: 0 = not allowed, 1 = only once, 0 . . . 1 = at most one, 0 . . . N = zero or more, and 1 . . . N = one or more.

In the above Table 7:
1. The Parameters includes the new model vector of values.
2. The New_model_id is the id of the new model when the server sends the model to one or more devices.

According to embodiments, there is also provided a “failure reporting message”. Error messages are used to handle unexpected errors or exceptions that may occur during the training process. For example, the server may send an error message to all devices to handle a device failure or network disruption.

According to embodiments, the behavior of device eligibility messages is from a network server, such as of network 502, and to a device, such as the device 501. The server sends a request to all devices to report a device failure or network disruption. For example, if a device fails to send its model parameters back to the server, the device should notify the server so that the device has been removed from the training process. This is implemented at S601 of FIG. 6 according to embodiments.

According to embodiments, the behavior of device eligibility messages is also from a device, such as the device 501, and to a network server, such as of network 502. The device sends a failure message to the server if a failure occurs. This is implemented at any of S602, S602′, S602″ of FIG. 6.

As for syntax of device eligibility messages, Table 8 is provided:

TABLE 8
Syntax (Failure reporting message)

| Type | Value | Syntax | Cardinality |
|---|---|---|---|
| Message_id | A unique value | integer | 1 |
| | identifying this | | |
| | message: | | |
| | Example: 4123 | | |
| Message_size | An integer shows the | integer | 1 |
| | length of the message | (Double) | |
| | body in bytes. | | |
| Message_type | “Failure Reporting” | string | 1 |
| Message | The message | string | 0 if the server sends |
| | reporting the failure. | | to the device |
| | Example: “Corrupted | | 1 if the device sends |
| | data received, need to | | to the server |
| | re-run the training” | | |

Cardinality: 0 = not allowed, 1 = only once, 0 . . . 1 = at most one, 0 . . . N = zero or more, and 1 . . . N = one or more.

In the above Table 8, the Message describe the reason for the failure.

As such, according to embodiments herein, there is provided also a set of control messages to be used during AI/ML federated learning with common headers wherein the message id, type, and size are defined, wherein various types are developed including a) eligibility for defining which devices are eligible to participate in, b) synchronization of model devaluation by defining what time a specific round of evaluation need to start, c) to request an evaluation of a newly downloaded model with local data, d) to report the evaluation per request, or to report the evaluation at the end of a specific round of training e) to send an updated model and finally f) to request for reporting any failure and reporting the failures.

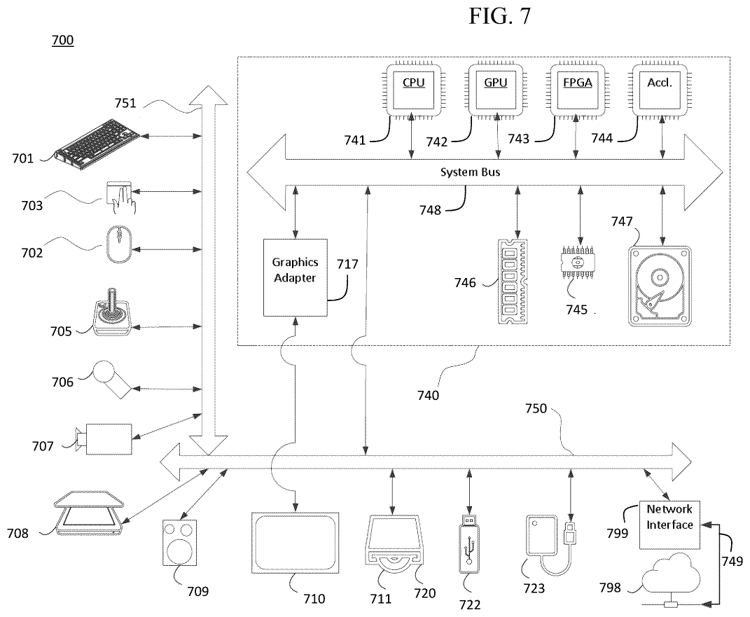

The techniques described above, can be implemented as computer software using computer-readable instructions and physically stored in one or more computer-readable media or by a specifically configured one or more hardware processors. For example, FIG. 7 shows a computer system 700 suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 7 for computer system 700 are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system 700.

Computer system 700 may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard 701, mouse 702, trackpad 703, touch screen 710, joystick 705, microphone 706, scanner 708, camera 707.

Computer system 700 may also include certain human interface output devices. Such human interface output devices may be stimulating the senses of one or more human users through, for example, tactile output, sound, light, and smell/taste. Such human interface output devices may include tactile output devices (for example tactile feedback by the touch-screen 710, or joystick 705, but there can also be tactile feedback devices that do not serve as input devices), audio output devices (such as: speakers 709, headphones (not depicted)), visual output devices (such as screens 710 to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system 700 can also include human accessible storage devices and their associated media such as optical media including CD/DVD ROM/RW 720 with CD/DVD 711 or the like media, thumb-drive 722, removable hard drive or solid state drive 723, legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system 700 can also include interface 799 to one or more communication networks 798. Networks 798 can for example be wireless, wireline, optical. Networks 798 can further be local, wide-area, metropolitan, vehicular and industrial, real-time, delay-tolerant, and so on. Examples of networks 798 include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks 798 commonly require external network interface adapters that attached to certain general-purpose data ports or peripheral buses (750 and 751) (such as, for example USB ports of the computer system 700; others are commonly integrated into the core of the computer system 700 by attachment to a system bus as described below (for example Ethernet interface into a PC computer system or cellular network interface into a smartphone computer system). Using any of these networks 798, computer system 700 can communicate with other entities. Such communication can be uni-directional, receive only (for example, broadcast TV), uni-directional send-only (for example CANbusto certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core 740 of the computer system 700.

The core 740 can include one or more Central Processing Units (CPU) 741, Graphics Processing Units (GPU) 742, a graphics adapter 717, specialized programmable processing units in the form of Field Programmable Gate Areas (FPGA) 743, hardware accelerators for certain tasks 744, and so forth. These devices, along with Read-only memory (ROM) 745, Random-access memory 746, internal mass storage such as internal non-user accessible hard drives, SSDs, and the like 747, may be connected through a system bus 748. In some computer systems, the system bus 748 can be accessible in the form of one or more physical plugs to enable extensions by additional CPUs, GPU, and the like. The peripheral devices can be attached either directly to the core's system bus 748, or through a peripheral bus 749. Architectures for a peripheral bus include PCI, USB, and the like.

CPUs 741, GPUs 742, FPGAs 743, and accelerators 744 can execute certain instructions that, in combination, can make up the aforementioned computer code. That computer code can be stored in ROM 745 or RAM 746. Transitional data can be also be stored in RAM 746, whereas permanent data can be stored for example, in the internal mass storage 747. Fast storage and retrieval to any of the memory devices can be enabled through the use of cache memory, that can be closely associated with one or more CPU 741, GPU 742, mass storage 747, ROM 745, RAM 746, and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture 700, and specifically the core 740 can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core 740 that are of non-transitory nature, such as core-internal mass storage 747 or ROM 745. The software implementing various embodiments of the present disclosure can be stored in such devices and executed by core 740. A computer-readable medium can include one or more memory devices or chips, according to particular needs. The software can cause the core 740 and specifically the processors therein (including CPU, GPU, FPGA, and the like) to execute particular processes or particular parts of particular processes described herein, including defining data structures stored in RAM 746 and modifying such data structures according to the processes defined by the software. In addition or as an alternative, the computer system can provide functionality as a result of logic hardwired or otherwise embodied in a circuit (for example: accelerator 744), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method for artificial intelligence/machine learning (AI/ML) federated learning, the method comprising:
enveloping a message, of one or more federated learning messages, by a control message format, the control message format comprising a plurality of fields respectively indicating ones of an identifier of the message, a size of the message, a type of the message, and a body of the message; and
controlling the AI/ML federated learning based on the message enveloped by the control message format,
wherein the AI/ML federated learning comprises a server controlling a plurality of separate devices to implement federated portions the AI/ML federated learning and to respectively report results of implementing the federated portions from each of the plurality of separate devices to the server, and
wherein the body of the message indicates at least one of an AI/ML federated learning synchronization among the plurality of separate devices, an device eligibility of the AI/ML federated learning, a model evaluation of the AI/ML federated learning, a model update of the AI/ML federated learning, and an error of the AI/ML federated learning.

2. The method according to claim 1,
wherein the AI/ML federated learning comprises rounds of federated learning each being an iteration back and forth between the server and the plurality of separate devices, and
wherein the AI/ML federated learning is implemented in parallel at the plurality of separate devices.

3. The method according to claim 2, wherein the body of the message indicates the AI/ML federated learning synchronization among the plurality of devices and that, of a round of the rounds of the federated learning, the federated learning is to begin at a same time at each of the plurality of separated devices.

4. The method according to claim 1, wherein the body of the message indicates the device eligibility and one or more criteria of device eligibility for the AI/ML federated learning.

5. The method according to claim 4, wherein the one or more criteria of device eligibility for the AI/ML federated learning is any of an operating system, a processor speed, an available memory, an available image library, a number of images, a geographical location, an a language setting.

6. The method according to claim 1, wherein the model evaluation of the AI/ML federated learning instructs the plurality of separate devices to implement an evaluation of a model of the AI/ML federated learning.

7. The method according to claim 1, wherein the model evaluation of the AI/ML federated learning instructs the plurality of separate devices to implement an evaluation of a model separate from the AI/ML federated learning.

8. The method according to claim 1, wherein the model update of the AI/ML federated learning instructs the plurality of separate devices to update parameters of a model of the AI/ML federated learning.

9. The method according to claim 1, wherein the model update is an instruction from the server to the plurality of separate devices.

10. The method according to claim 1, wherein the model update is an instruction from the at least one of the plurality of separate devices to the server.

11. An apparatus comprising:
at least one memory configured to store computer program code;
at least one processor configured to access the computer program code and operate as instructed by the computer program code, the computer program code including:
enveloping code configured to cause the at least one processor to envelope a message, of one or more federated learning messages, by a control message format, the control message format comprising a plurality of fields respectively indicating ones of an identifier of the message, a size of the message, a type of the message, and a body of the message; and
controlling code configured to cause the at least one processor to control artificial intelligence/machine learning (AI/ML) federated learning based on the message enveloped by the control message format,
wherein the AI/ML federated learning comprises a server controlling a plurality of separate devices to implement federated portions the AI/ML federated learning and to respectively report results of implementing the federated portions from each of the plurality of separate devices to the server, and
wherein the body of the message indicates at least one of an AI/ML federated learning synchronization among the plurality of separate devices, an device eligibility of the AI/ML federated learning, a model evaluation of the AI/ML federated learning, a model update of the AI/ML federated learning, and an error of the AI/ML federated learning.

12. The apparatus according to claim 11,
wherein the AI/ML federated learning comprises rounds of federated learning each being an iteration back and forth between the server and the plurality of separate devices, and
wherein the AI/ML federated learning is implemented in parallel at the plurality of separate devices.

13. The apparatus according to claim 12, wherein the body of the message indicates the AI/ML federated learning synchronization among the plurality of devices and that, of a round of the rounds of the federated learning, the federated learning is to begin at a same time at each of the plurality of separated devices.

14. The apparatus according to claim 11, wherein the body of the message indicates the device eligibility and one or more criteria of device eligibility for the AI/ML federated learning.

15. The apparatus according to claim 14, wherein the one or more criteria of device eligibility for the AI/ML federated learning is any of an operating system, a processor speed, an available memory, an available image library, a number of images, a geographical location, an a language setting.

16. The apparatus according to claim 11, wherein the model evaluation of the AI/ML federated learning instructs the plurality of separate devices to implement an evaluation of a model of the AI/ML federated learning.

17. The apparatus according to claim 11, wherein the model evaluation of the AI/ML federated learning instructs the plurality of separate devices to implement an evaluation of a model separate from the AI/ML federated learning.

18. The apparatus according to claim 11, wherein the model update of the AI/ML federated learning instructs the plurality of separate devices to update parameters of a model of the AI/ML federated learning.

19. The apparatus according to claim 11, wherein the model update is one of a first instruction, from the server to the plurality of separate devices, and a second instruction from the at least one of the plurality of separate devices to the server.

20. A non-transitory computer readable medium storing a program causing a computer to:
envelope a message, of one or more federated learning messages, by a control message format, the control message format comprising a plurality of fields respectively indicating ones of an identifier of the message, a size of the message, a type of the message, and a body of the message; and
control the artificial intelligence/machine learning (AI/ML) federated learning based on the message enveloped by the control message format,
wherein the AI/ML federated learning comprises a server controlling a plurality of separate devices to implement federated portions the AI/ML federated learning and to respectively report results of implementing the federated portions from each of the plurality of separate devices to the server, and
wherein the body of the message indicates at least one of an AI/ML federated learning synchronization among the plurality of separate devices, an device eligibility of the AI/ML federated learning, a model evaluation of the AI/ML federated learning, a model update of the AI/ML federated learning, and an error of the AI/ML federated learning.
